(19) United States
(12) Patent Application Publication
(10) Pub. No.: US 2019/0034973 A1
(43) Pub. Date: Jan. 31, 2019

(54) SYSTEMS AND METHODS FOR AUTOMATED AUDIENCE IDENTIFICATION

(71) Applicant: Facebook, Inc., Menlo Park, CA (US)

(72) Inventors: Jinyi Yao, Issaquah, WA (US); Martin Schatz, Seattle, WA (US); Arash Ashari, Kirkland, WA (US); Vijay Rangarajan, Sunnyvale, CA (US); Liushan Yang, Seattle, WA (US); Iris Yui Chang, Seattle, WA (US)

(21) Appl. No.: 15/660,786

(22) Filed: Jul. 26, 2017

(51) Int. Cl. G06Q 30/02; G06Q 50/00

(52) U.S. Cl. CPC G06Q 30/0269; G06Q 50/01

(57) ABSTRACT

Systems, methods, and non-transitory computer-readable media can identify a target page and an advertising campaign comprising one or more advertisements associated with the target page. One or more users are identified for inclusion in a base audience based on page information associated with the target page. One or more users are identified for inclusion in an expanded audience based on expanded audience criteria. The advertising campaign is presented to a smart audience comprising the base audience and the expanded audience.

### FIELD OF THE INVENTION

The present technology relates to the field of social networking systems. More particularly, the present technology relates to systems and methods for automated audience identification on a social networking system.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system can include pages that are associated with users or entities. The pages can be dedicated locations on the social networking system to reflect the presence of the users and entities on the social networking system. The users and entities associated with such pages can be provided with the opportunity to interact with other users on the social networking system. For example, the users and entities associated with pages can be given the ability to provide advertisements to other users on the social networking system.

### SUMMARY

Various embodiments of the present disclosure can include systems, methods, and non-transitory computer readable media configured to identify a target page and an advertising campaign comprising one or more advertisements associated with the target page. One or more users are identified for inclusion in a base audience based on page information associated with the target page. One or more users are identified for inclusion in an expanded audience based on expanded audience criteria. The advertising campaign is presented to a smart audience comprising the base audience and the expanded audience.

In an embodiment, the identifying one or more users for inclusion in the base audience comprises identifying, for inclusion in the base audience, one or more users that have engaged with the target page.

In an embodiment, the expanded audience criteria comprise the page information associated with the target page.

In an embodiment, the identifying one or more users for inclusion in the expanded audience comprises identifying one or more pages similar to the target page based on page similarity criteria; and identifying, for inclusion in the expanded audience, one or more users that have engaged with at least one page of the one or more pages similar to the target page.

In an embodiment, the expanded audience criteria comprise base audience information associated with the base audience.

In an embodiment, the identifying one or more users for inclusion in the expanded audience comprises: identifying, for inclusion in the expanded audience, one or more users that are similar to the one or more users of the base audience based on user similarity criteria.

In an embodiment, the identifying, for inclusion in the expanded audience, one or more users that are similar to the one or more users of the base audience comprises: determining a representative user based on an aggregation of the one or more users of the base audience; and identifying, for inclusion in the expanded audience, one or more users that are similar to the representative user based on user similarity criteria.

In an embodiment, the identifying one or more users for inclusion in the expanded audience is performed based on a determination that the base audience does not exceed a smart audience size threshold.

In an embodiment, the presenting the advertising campaign to a smart audience is performed based on a determination that the smart audience satisfies a smart audience size threshold.

In an embodiment, an indication is received that the advertising campaign resulted in a positive response from a first user. The base audience is updated to include the first user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a smart audience module, according to an embodiment of the present disclosure.

FIG. 2 illustrates an example expanded audience module, according to various embodiments of the present disclosure.

FIG. 3 illustrates an example advertising campaign module, according to various embodiments of the present disclosure.

FIG. 4 illustrates an example functional block diagram associated with automated audience identification, according to an embodiment of the present disclosure.

FIG. 5 illustrates an example method associated with automated audience identification, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Automated Audience Identification

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. The pages can be dedicated locations on the social networking system to reflect the presence of the entities on the social networking system. A page can publish content that is deemed relevant to its associated entity to promote engagement with the page. In this regard, pages, or entities associated with pages, can publish advertisements that may be distributed and/or presented to other users on the social networking system. Advertisements published by a page may, for example, be presented on newsfeeds of one or more users on the social networking system.

Under conventional approaches, entities looking to advertise goods or services to other users have attempted to tailor advertisements based on expected demographics of potential viewers. However, generation of advertisements based on expected viewer demographics can lead to many consumers encountering advertisements that are irrelevant or uninteresting to them. With the advent of personalized or targeted advertisements, advertisements may be matched to individual users according to known traits of those users. However, producers of advertisements often have limited information about users, and, as such, may miss opportunities for presenting users with relevant advertisements due to the lack of information. Furthermore, a poor choice in targeting can negatively impact consumers' impressions of an entity or its goods and/or services. Knowing which users to target with a particular advertisement can be difficult for various reasons. For example, in large networked environments, such as a social networking system, the number of potential user targets can be overwhelming, and various targeting options can draw arbitrary boundaries around important consumer populations. The complexity of these issues can be magnified for small businesses, as resources that can be devoted to understanding these complexities may be limited. Accordingly, conventional approaches may not be effective in addressing these and other problems arising in computer technology.

An improved approach rooted in computer technology overcomes the foregoing and other disadvantages associated with conventional approaches specifically arising in the realm of computer technology. In general, a smart audience comprising a plurality of users can be automatically determined based on page information associated with a target page. In various embodiment, the smart audience can include a base audience and an expanded audience. In certain embodiments, one or more users can be identified for inclusion in the base audience based on the page information. The page information can include page engagement information indicative of user engagements with the target page. The base audience can include one or more users that have engaged with the target page. In various embodiments, one or more users can be identified for inclusion in the expanded audience based on the base audience and the page information. For example, the expanded audience can include one or more users that have engaged with other pages that are determined to be similar to the target page. In another example, the expanded audience can include one or more users that are determined to be similar to users in the base audience. A smart audience can include the one or more users in the base audience and the one or more users in the expanded audience. An advertising campaign comprising one or more advertisements associated with the target page can be presented to the smart audience. In certain embodiments, results of the advertising campaign can be utilized to update the smart audience.

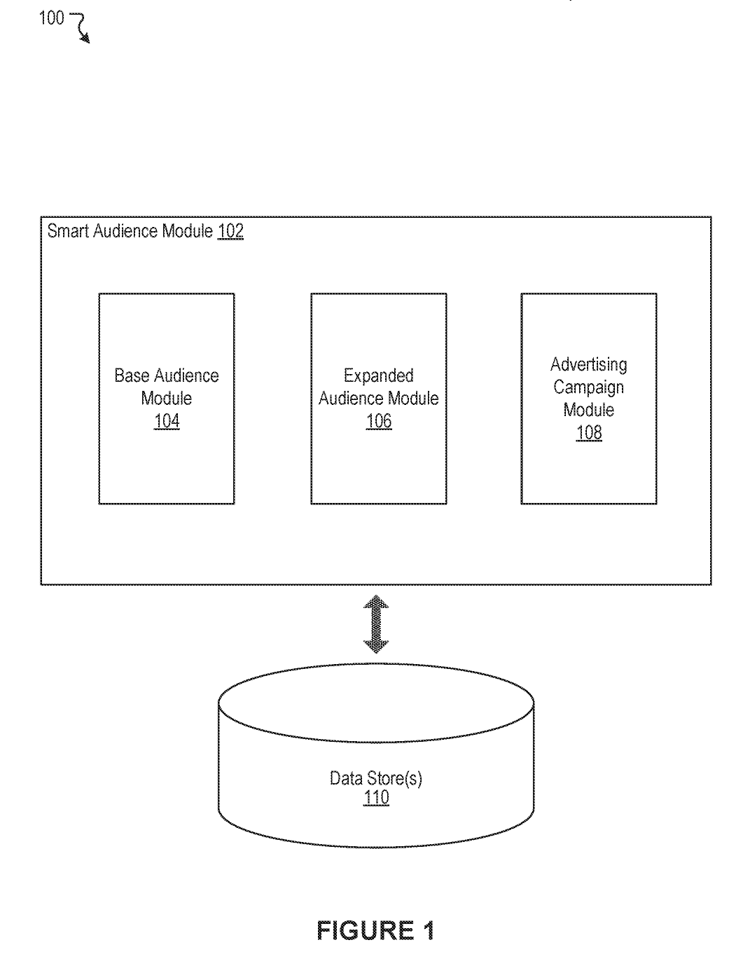

FIG. 1 illustrates an example system 100 including an example smart audience module 102, according to an embodiment of the present disclosure. The smart audience module 102 can be configured to automatically determine a smart audience for a target page based on page information associated with the target page. In various embodiments, the smart audience can include a base audience and an expanded audience. In some embodiments, the smart audience module 102 can be configured to identify one or more users for inclusion in the base audience based on the page information. The page information can include, for example, page engagement information indicative of user engagements with the target page. In various embodiments, the smart audience module 102 can be configured to identify one or more users that have engaged with the target page, and to include such users in the base audience. The smart audience module 102 can be further configured to identify one or more users for inclusion in the expanded audience based on expanded audience criteria. The expanded audience criteria can include the page information. For example, the smart audience module 102 can be configured to identify a page similarity expanded audience comprising one or more users that have engaged with one or more pages determined to be similar to the target page. The expanded audience criteria can include base audience information associated with the base audience. For example, the smart audience module 102 can be configured to identify a user similarity expanded audience comprising one or more users determined to be similar to the one or more users in the base audience. The expanded audience can include all users in the page similarity expanded audience and all users in the user similarity expanded audience. The base audience and the expanded audience can be combined to form the smart audience. In various embodiments, the smart audience module 102 can be configured to present an advertising campaign comprising one or more advertisements associated with the target page to the smart audience. In certain embodiments, the smart audience module 102 can utilize results of the advertising campaign to update the smart audience.

In certain embodiments, a page can be associated with a plurality of smart audiences. For example, the page can have a plurality of advertisements or a plurality of advertising campaigns, and the page can have different smart audiences for different advertisements or advertising campaigns. More details regarding the present disclosure are provided herein.

As shown in the example of FIG. 1, the smart audience module 102 can include a base audience module 104, an expanded audience module 106, and an advertising campaign module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the smart audience module 102 can be implemented in any suitable combinations.

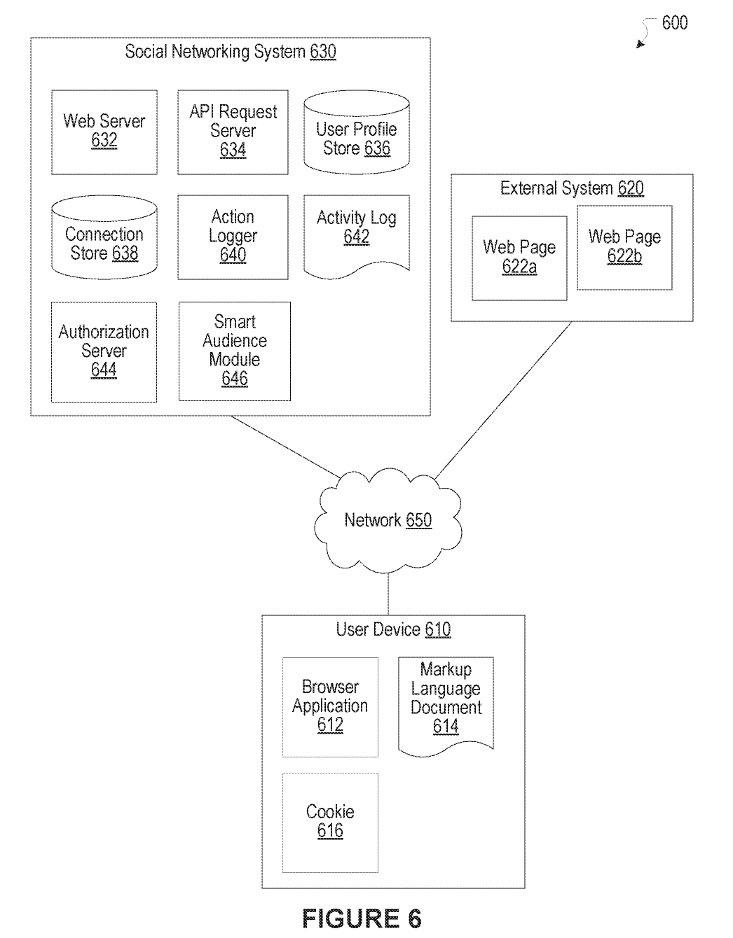

In some embodiments, the smart audience module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the smart audience module 102 can be implemented, in part or in whole, as software running on one or more computing devices or systems, such as on a user or client computing device. For example, the smart audience module 102, or at least a portion thereof, can be implemented as or within an application (e.g., app), a program, or an applet, etc., running on a user computing device or a client computing system, such as the user device 610 of FIG. 6. In another example, the smart audience module 102, or at least a portion thereof, can be implemented using one or more computing devices or systems that include one or more servers, such as network servers or cloud servers. In some instances, the smart audience module 102 can, in part or in whole, be implemented within or configured to operate in conjunction with a social networking system (or service), such as the social networking system 630 of FIG. 6. It should be understood that there can be many variations or other possibilities.

The smart audience module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the smart audience module 102. For example, the data store 110 can store page information associated with one or more pages, one or more advertising campaigns, audience information for one or more pages and/or advertising campaigns, one or more page similarity models, one or more user similarity models, expanded audience criteria, and the like. It is contemplated that there can be many variations or other possibilities.

The base audience module 104 can be configured to identify a base audience comprising one or more users based on page information associated with a target page. In various embodiments, the page information can include page engagement information indicative of user engagements with the target page. The base audience module 104 can select for inclusion in the base audience all users that have engaged with the target page in various ways. For example, one or more possible engagement types or types of actions that can be taken with respect to a target page may be identified as high intent actions. The base audience module 104 can select for inclusion in the base audience all users that have taken a high intent action with respect to the target page. User engagement types and high intent actions can include, for example, clicking on a call-to-action button or a link on a page, sending a message to a page, getting directions to a physical location associated with a page, writing a review on a page, responding to or otherwise engaging with posts and/or events associated with a page, commenting on a page, and the like.

In certain embodiments, the base audience module 104 can be configured to identify one or more users for the base audience based on advertisement information associated with one or more advertisements. For example, advertisement information can indicate an advertisement type for an advertisement that a target page intends to publish or has published. In various embodiments, selection of users for the base audience may vary based on the advertisement type of an advertisement. For example, if an advertisement is a general awareness advertisement, various engagement types may be identified as high intent actions, e.g., messaging a target page, responding to an event invitation by a target page, selecting a call-to-action button on a target page, etc. As such, users that have taken any of those actions with respect to a target page may be included in the base audience. However, if an advertisement includes a particular feature, such as a request to respond to an event associated with the page, the base audience module 104 can be configured to include in the base audience only those users that have previously participated in an event associated with the target page. Many variations are possible.

The expanded audience module 106 can be configured to identify one or more users for inclusion in an expanded audience based on expanded audience criteria. In various embodiments, the expanded audience criteria can include page information associated with a target page. For example, the expanded audience module 106 can be configured to identify a page similarity expanded audience comprising one or more users that have engaged with (e.g., taken a high intent action with respect to) one or more pages determined to be similar to the target page. In various embodiments, the expanded audience criteria can include base audience information associated with a base audience, such as a base audience identified by the base audience module 104. For example, the expanded audience module 106 can be configured to identify a user similarity expanded audience comprising one or more users determined to be similar to the one or more users in the base audience. In various embodiments, the expanded audience can include all users selected for inclusion in the page similarity expanded audience and the user similarity expanded audience.

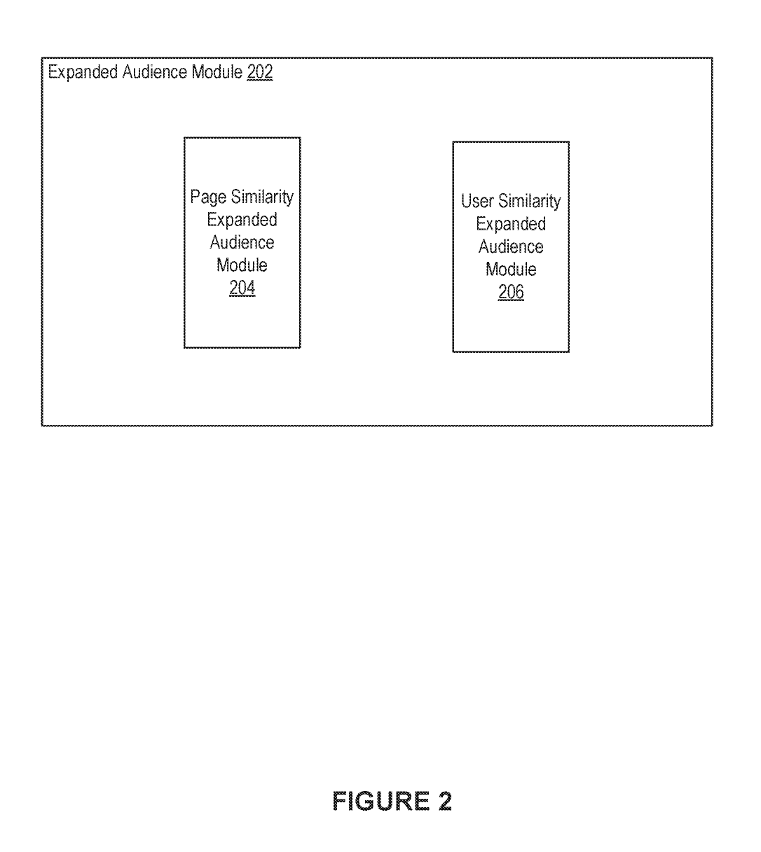

As described above, a base audience and an expanded audience can be combined into a smart audience for an advertising campaign. In certain embodiments, the expanded audience module 106 can be configured to identify users for inclusion in an expanded audience based on a determination that a smart audience size threshold has not been exceeded. For example, if a base audience exceeds the smart audience size threshold, this may indicate that a smart audience can be composed entirely of users from the base audience, and additional users may not be required for the smart audience. As such, the expanded audience module 106 need not identify an expanded audience. However, if the base audience does not exceed the smart audience size threshold, then it may be desirable to add additional users to the smart audience, and the expanded audience module 106 can identify additional users for inclusion in the smart audience based on expanded audience criteria. The smart audience size threshold can vary based on page information associated with a target page. For example, the smart audience size threshold can be determined based on a number of followers of the target page. Further to this example, a target page having a greater number of followers may have a higher smart audience size threshold than a target page have a smaller number of followers. The expanded audience module 106 is described in greater detail herein with reference to FIG. 2.

The advertising campaign module 108 can be configured to present an advertising campaign comprising one or more advertisements associated with a target page to an automatically determined smart audience comprising one or more users. In various embodiments, and as described above, the smart audience can include all users in a base audience (e.g., as determined by the base audience module 104) and all users in an expanded audience (e.g., as determined by the expanded audience module 106). The advertising campaign module 108 can be configured to periodically update the smart audience based on results of the advertising campaign.

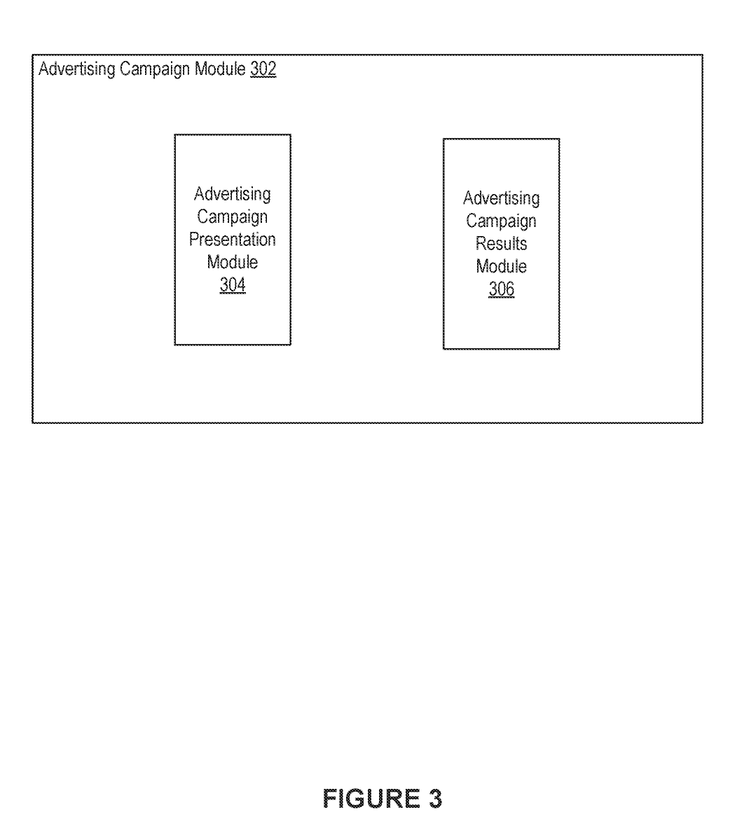

In certain embodiments, the advertising campaign module 108 can be configured to present an advertising campaign to a smart audience only if the smart audience satisfies a smart audience size threshold. For example, if a smart audience contains fewer users than is required by the smart audience size threshold, the advertising campaign module 108 can be configured to not present an advertising campaign to the smart audience. Conversely, if the smart audience satisfies the smart audience size threshold, the advertising campaign can be presented to the users in the smart audience. In various embodiments, the smart audience size threshold implemented by the advertising campaign module 108 may be the same as the smart audience size threshold implemented by the expanded audience module 106. In certain embodiments, the smart audience size threshold implemented by the advertising campaign module 108 may be different from the smart audience size threshold implemented by the expanded audience module 106. The advertising campaign module 108 is described in greater detail herein with reference to FIG. 3.

FIG. 2 illustrates an example expanded audience module 202 configured to automatically identify one or more users for inclusion in an expanded audience based on expanded audience criteria, according to an embodiment of the present disclosure. In some embodiments, the expanded audience module 106 of FIG. 1 can be implemented as the expanded audience module 202. As shown in the example of FIG. 2, the expanded audience module 202 can include a page similarity expanded audience module 204 and a user similarity expanded audience module 206.

The page similarity expanded audience module 204 can be configured to identify one or more users for inclusion in an expanded audience based on page information associated with a target page. In various embodiments, the page similarity expanded audience module 204 can identify users that have engaged with (e.g., taken a high intent action with regard to) a page that is determined to be similar to the target page.

In this regard, the page similarity expanded audience module 204 can be configured to identify a set of similar pages comprising one or more pages that are determined to be similar to the target page based on page similarity criteria. Page similarity criteria can include, for example, similarity in audience size (e.g., the number of followers within a threshold number or percentage), similarity in audience membership (e.g., a threshold number of users or proportion of users that follow both pages), similarity in location (e.g., within a threshold distance radius, global v. local, etc.), similarity in types of content produced (e.g., content values within a threshold value), and the like. Page similarity criteria can also include, for example, similarity in industry or category. In certain embodiments, page similarity can be determined by training one or more page similarity machine learning models to determine similarities between pages. For example, the one or more page similarity machine learning models can be trained based on manual categorizations of similar pages. In certain embodiments, various page similarity criteria can be combined to determine an overall page similarity score. For example, the one or more page similarity machine learning models can be trained to output page similarity scores. A page similarity score for a first page may be indicative of how similar the first page is to a target page. Pages that satisfy a page similarity score threshold can be selected for inclusion in the set of similar pages.

The page similarity expanded audience module 204 can be further configured to identify one or more users that have engaged with a page in the set of similar pages. Such users can be included in an expanded audience. For example, any users that have taken a high intent action with respect to a page in the set of similar pages can be selected for inclusion in the expanded audience.

In certain embodiments, the page similarity expanded audience module 204 can assign user scores to users. In various embodiments, user scores may be determined based on page similarity scores. For example, if a first user has taken a high intent action with respect to a first page of a set of similar pages, and the first page has a first page similarity score, the first user can be assigned a user score based on the first page similarity score. User scores can also vary, in various embodiments, based on an engagement type undertaken by the user with respect to a page in the set of similar pages. For example, certain engagement types may be preferred over others (e.g., selection of a call-to-action button may be preferred over sending a message to a page or liking a content post on the page). Therefore, certain preferred engagement types may result in higher user scores than engagement types that are less preferred. The page similarity expanded audience module 204 can rank and/or filter users based on user scores. For example, in various embodiments, users satisfying a user score threshold may be selected for inclusion in the expanded audience, while users that do not satisfy the user score threshold may be excluded.

The user similarity expanded audience module 206 can be configured to identify one or more users for inclusion in an expanded audience based on base audience information associated with a base audience. For example, the base audience may be a base audience identified by the base audience module 104 of FIG. 1. The base audience may include, for example, one or more users that have engaged with (e.g., taken a high intent action with regard to) a target page. In various embodiments, the user similarity expanded audience module 206 can identify for inclusion in the expanded audience one or more users that are determined to be similar to one or more users in the base audience based on user similarity criteria. In various embodiments, users in the base audience can be aggregated into a single, representative user. In such embodiments, user similarity determinations can be made based on the representative user. In other embodiments, user similarity determinations can be made with respect to individual users in the base audience.

In certain embodiments, user similarity criteria can be implemented by training one or more user similarity machine learning models to determine similarities between users. Various examples of identifying similar users based on models are described in U.S. Patent Application Publication No. 2015/0332336, entitled “Runtime Expansion of Targeting Criteria Based on User Characteristics,” filed on May 29, 2014, the entire contents of which are incorporated by reference as if fully set forth herein.

In various embodiments, the user similarity expanded audience module 206 can be configured to calculate user scores for users. A user score for a first user can be indicative of a degree of similarity between the first user and a user in the base audience, or a representative user associated with the base audience. The user similarity expanded audience module 206 can be configured to rank and/or filter users based on user scores. For example, users satisfying a user score threshold may be selected for inclusion in the expanded audience, while users that do not satisfy the user score threshold may be excluded.

FIG. 3 illustrates an example advertising campaign module 302 configured to present one or more advertisements associated with a target page to one or more users in a smart audience, according to an embodiment of the present disclosure. In some embodiments, the advertising campaign module 108 of FIG. 1 can be implemented as the advertising campaign module 302. As shown in the example of FIG. 3, the advertising campaign module 302 can include an advertising campaign presentation module 304 and an advertising campaign results module 306.

The advertising campaign presentation module 304 can be configured to present one or more advertisements associated with a target page to one or more users of a smart audience. For example, one or more advertisements associated with the target page can be presented on a newsfeed of each user of the smart audience. When users are presented with an advertisement, users may be given the opportunity to engage and/or interact with the advertisement.

The advertising campaign results module 306 can be configured to update a smart audience based on advertising campaign results. As discussed above, a user of a smart audience that is presented with an advertisement may be given the opportunity to engage with the advertisement. For example, the advertisement may be for an event associated with a target page, and the user may be given the opportunity to attend and/or participate in the event. In another example, the advertisement may include a link to a webpage associated with a target page, and the user can click through to the webpage via the advertisement. In various embodiments, if presentation of an advertisement to a user results in a positive result or response (e.g., the user engages in a call-to-action presented in the advertisement), the advertising campaign results module 306 can be configured to update a smart audience associated with the advertisement based on the positive result or response. For example, if an indication is received that an advertisement resulted in a positive result from a first user, a base audience can be updated to include the first user. In this way, as an advertising campaign progresses, a base audience associated with the advertising campaign can be continually updated to include users that have responded positively to the advertising campaign. By including such users in the base audience, other users similar to those users can be identified and included in an expanded audience associated with the base audience. In this way, the advertising campaign results module 306 can periodically update the base audience, which may result in the expanded audience being periodically updated based on changes to the base audience, and the smart audience can continually be refreshed and improved over time.

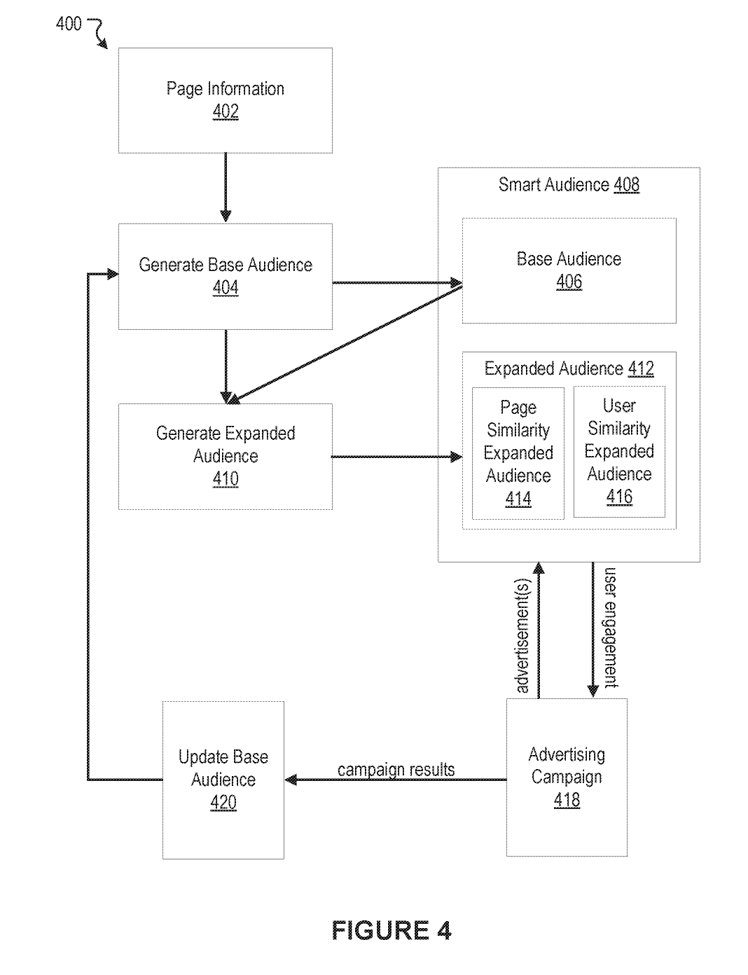

FIG. 4 illustrates an example functional block diagram 400 associated with automated audience identification, according to various embodiments of the present disclosure. The example functional block diagram 400 demonstrates how a smart audience 408 can be automatically determined for an advertising campaign associated with a target page. At block 404, a base audience 406 is generated based on page information 402 associated with the target page. At block 410, an expanded audience 412 is generated based on the base audience 406 and the page information 402. The expanded audience 412 includes a page similarity expanded audience 414 and a user similarity expanded audience 416. The base audience 406 and the expanded audience 412 together form a smart audience 408. An advertising campaign 418 associated with the target page is provided to the smart audience 408. Users in the smart audience are able to engage with the advertising campaign. At block 420, the base audience 406 is updated based on campaign results from the advertising campaign 418.

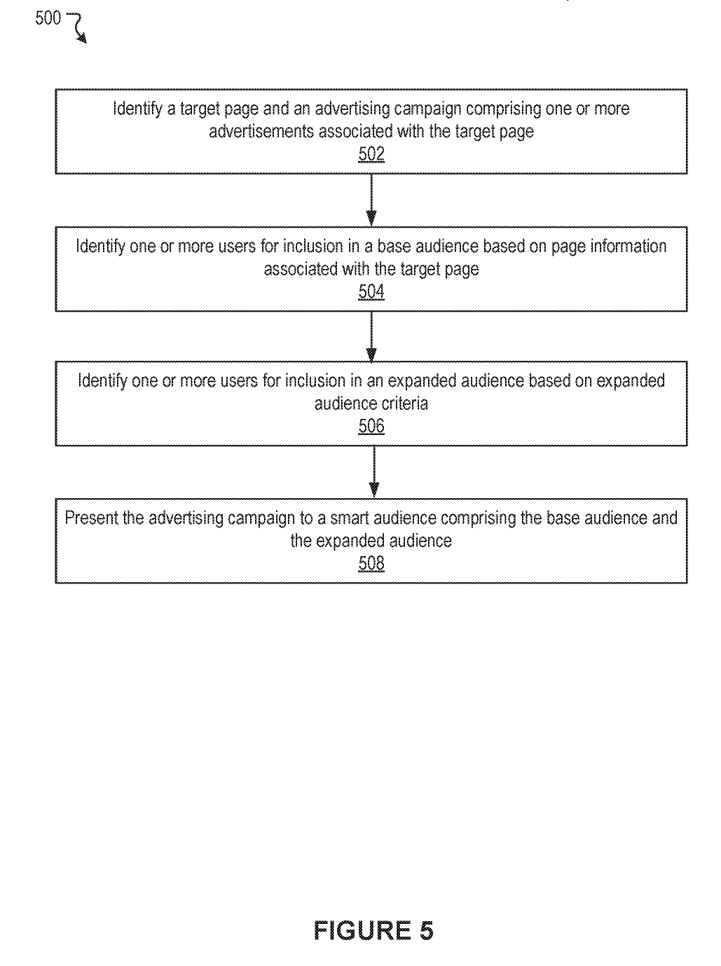

FIG. 5 illustrates an example method 500 associated with automated audience identification, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can identify a target page and an advertising campaign comprising one or more advertisements associated with the target page. At block 504, the example method 500 can identify one or more users for inclusion in a base audience based on page information associated with the target page. At block 506, the example method 500 can identify one or more users for inclusion in an expanded audience based on expanded audience criteria. At block 508, the example method 500 can present the advertising campaign to a smart audience comprising the base audience and the expanded audience.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a smart audience module 646. The smart audience module 646 can, for example, be implemented as the smart audience module 102, as discussed in more detail herein. As discussed previously, it should be appreciated that there can be many variations or other possibilities. For example, in some embodiments, one or more functionalities of the smart audience module 646 can be implemented in the user device 610.

### Hardware Implementation

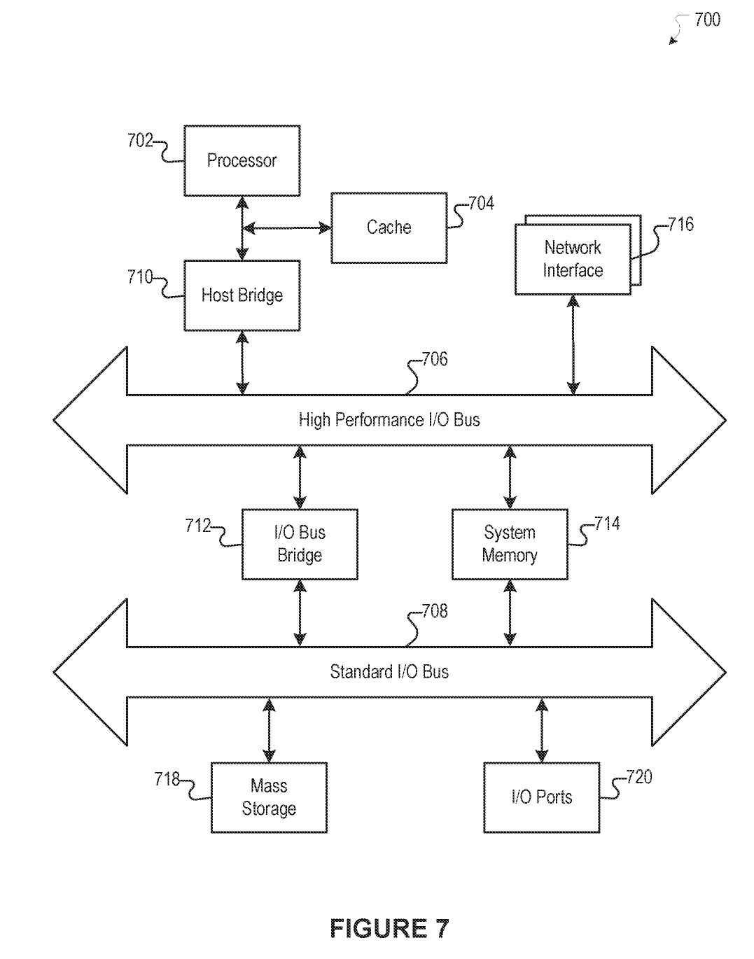

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying, by a computing system, a target page and an advertising campaign comprising one or more advertisements associated with the target page;
identifying, by the computing system, one or more users for inclusion in a base audience based on page information associated with the target page;
identifying, by the computing system, one or more users for inclusion in an expanded audience based on expanded audience criteria; and
presenting, by the computing system, the advertising campaign to a smart audience comprising the base audience and the expanded audience.

2. The computer-implemented method of claim 1, wherein the identifying one or more users for inclusion in the base audience comprises identifying, for inclusion in the base audience, one or more users that have engaged with the target page.

3. The computer-implemented method of claim 1, wherein the expanded audience criteria comprise the page information associated with the target page.

4. The computer-implemented method of claim 3, wherein the identifying one or more users for inclusion in the expanded audience comprises:
identifying one or more pages similar to the target page based on page similarity criteria; and
identifying, for inclusion in the expanded audience, one or more users that have engaged with at least one page of the one or more pages similar to the target page

5. The computer-implemented method of claim 1, wherein the expanded audience criteria comprise base audience information associated with the base audience.

6. The computer-implemented method of claim 5, wherein the identifying one or more users for inclusion in the expanded audience comprises:
identifying, for inclusion in the expanded audience, one or more users that are similar to the one or more users of the base audience based on user similarity criteria.

7. The computer-implemented method of claim 6, wherein the identifying, for inclusion in the expanded audience, one or more users that are similar to the one or more users of the base audience comprises:
determining a representative user based on an aggregation of the one or more users of the base audience; and
identifying, for inclusion in the expanded audience, one or more users that are similar to the representative user based on user similarity criteria.

8. The computer-implemented method of claim 1, wherein the identifying one or more users for inclusion in the expanded audience is performed based on a determination that the base audience does not exceed a smart audience size threshold.

9. The computer-implemented method of claim 1, wherein the presenting the advertising campaign to a smart audience is performed based on a determination that the smart audience satisfies a smart audience size threshold.

10. The computer-implemented method of claim 1, further comprising
receiving an indication that the advertising campaign resulted in a positive response from a first user, and
updating the base audience to include the first user.

11. A system comprising:
at least one processor; and
a memory storing instructions that, when executed by the at least one processor, cause the system to perform a method comprising:
identifying a target page and an advertising campaign comprising one or more advertisements associated with the target page;
identifying one or more users for inclusion in a base audience based on page information associated with the target page;
identifying one or more users for inclusion in an expanded audience based on expanded audience criteria; and
presenting the advertising campaign to a smart audience comprising the base audience and the expanded audience.

12. The system of claim 11, wherein the identifying one or more users for inclusion in the base audience comprises identifying, for inclusion in the base audience, one or more users that have engaged with the target page.

13. The system of claim 11, wherein the expanded audience criteria comprise the page information associated with the target page.

14. The system of claim 13, wherein the identifying one or more users for inclusion in the expanded audience comprises:
identifying one or more pages similar to the target page based on page similarity criteria; and
identifying, for inclusion in the expanded audience, one or more users that have engaged with at least one page of the one or more pages similar to the target page

15. The system of claim 11, wherein the expanded audience criteria comprise base audience information associated with the base audience.

16. A non-transitory computer-readable storage medium including instructions that, when executed by at least one processor of a computing system, cause the computing system to perform a method comprising:
identifying a target page and an advertising campaign comprising one or more advertisements associated with the target page;
identifying one or more users for inclusion in a base audience based on page information associated with the target page;
identifying one or more users for inclusion in an expanded audience based on expanded audience criteria; and
presenting the advertising campaign to a smart audience comprising the base audience and the expanded audience.

17. The non-transitory computer-readable storage medium of claim 16, wherein the identifying one or more users for inclusion in the base audience comprises identifying, for inclusion in the base audience, one or more users that have engaged with the target page.

18. The non-transitory computer-readable storage medium of claim 16, wherein the expanded audience criteria comprise the page information associated with the target page.

19. The non-transitory computer-readable storage medium of claim 18, wherein the identifying one or more users for inclusion in the expanded audience comprises:
identifying one or more pages similar to the target page based on page similarity criteria; and
identifying, for inclusion in the expanded audience, one or more users that have engaged with at least one page of the one or more pages similar to the target page

20. The non-transitory computer-readable storage medium of claim 16, wherein the expanded audience criteria comprise base audience information associated with the base audience.
